(19) United States
(12) Patent Application Publication
(10) Pub. No.: US 2025/0225175 A1
(43) Pub. Date: Jul. 10, 2025

(54) OBJECT SEARCH VIA RE-RANKING

(71) Applicant: HANWHA VISION CO., LTD., Seongnam-si (KR)

(72) Inventors: Sungyeon PARK, Seongnam-si (KR); Hyunhak SHIN, Seongnam-si (KR)

(73) Assignee: HANWHA VISION CO., LTD., Seongnam-si (KR)

(21) Appl. No.: 18/724,412

(22) PCT Filed: Aug. 18, 2022
(86) PCT No.: PCT/KR2022/012313

§ 371 Date: Jun. 26, 2024

(30) Foreign Application Priority Data
Jan. 7, 2022 (KR) 10-2022-0002789

(51) Int. Cl. G06F 16/532; G06F 16/51; G06F 16/56; G06F 16/583; G06F 16/587; G06V 10/82

(52) U.S. Cl. CPC G06F 16/532; G06F 16/51; G06F 16/56; G06F 16/583; G06F 16/587; G06V 10/82

(57) ABSTRACT

A device and a method for image search in a surveillance camera system are disclosed. An image search device according to an embodiment of the present specification comprises a database for storing images captured from a plurality of cameras spaced apart from each other and metadata of the images, wherein, when a probe image is input, the device restricts a search range for searching for the same person as a person of interest in the probe image according to a predetermined criterion, performs primary ranking on an image within the restricted search range on the basis of feature vector information of the image, and then performs re-ranking according to an additional image similarity on the basis of a result of the primary ranking. Accordingly, the accuracy of an image search can be improved while reducing the amount of computation required for the image search. In the present specification, one or more among a surveillance camera, an autonomous vehicle, a user terminal, and a server may be linked to an artificial intelligence module, a robot, an augmented reality (AR) device, a virtual reality (VR) device, a device related to 5G services, and the like.

### TECHNICAL FIELD

The present specification relates to a device and method for searching for a person through a re-ranking technique.

### BACKGROUND ART

A re-ranking algorithm is a method of improving the quality of search results by calculating the degree of association of each of the search results with a query, instead of directly altering an internal structure of an image search system.

The re-ranking algorithm is advantageous from a developmental perspective in that the re-ranking algorithm does not require specifically recognizing an internal structure of an image search system, and in that an additional algorithm is applicable without modifying the existing system.

The re-ranking algorithm originates from pseudo relevance feedback. In contrast to relevance feedback in which a human gives feedback about results through supervised learning, pseudo relevance feedback is a method in which feedback is given through unsupervised learning. This unsupervised learning is done mainly by using information on a ranking list of an initial image search and visual information on search result images, which is a characteristic that can be used in a re-ranking step.

In general, in a technique of looking and searching for the same person, while images acquired from a plurality of cameras are stored in a storage device, it is not easy to search for exactly the same person if there are vast amounts of data stored. To address this, feature information has recently been used that is extracted based on a deep learning network that is trained on multiple images captured at various points in time. However, one issue with this method is that it is difficult to obtain reliable search results if there is a number of people whose features extracted from a search are similar.

### DETAILED DESCRIPTION OF INVENTION

### Technical Problems

To overcome the aforementioned problems, an aspect of the present specification provides a method for searching for the same object more efficiently in images captured from a plurality of cameras spaced apart from each other, by performing primary ranking based on similarity between the images and then performing re-ranking based on Jaccard distances between the images.

Another aspect of the present specification is to provide a method for searching for the same object more efficiently in images captured from a plurality of cameras spaced apart from each other, by limiting the size of a target being searched for in a database, in order to solve the problem of the rapid increase in the amount of computation needed to calculate the similarity between the images and calculate the Jaccard distances.

The aspects of the present disclosure are not limited to the foregoing, and other aspects not mentioned herein will be clearly understood by those skilled in the art from the following description.

### Technical Solution

An image search device according to an embodiment of the present specification includes: a database for storing images captured from a plurality of cameras spaced apart from each other and metadata of the images; and a processor that, when a probe image containing a person of interest is inputted, selects at least one image from the database, to search for an image containing the object of interest based on at least one predetermined criterion, extracts at least one candidate image similar to the probe image based on the distance between a feature vector of the probe image and a feature vector of the selected at least one image, and re-ranks the candidate image based on similarity between the probe image and the candidate image.

The similarity may be obtained based on Jaccard distance.

The metadata may include the sex of a person contained in the image, a feature vector, the time when the image was captured, and the location where the image was captured.

The processor may calculate differences between feature vectors of the plurality of images and store the same in the database, before receiving an image search request through the probe image input.

Upon receiving a first new image from one of the plurality of cameras, the processor may extract a first feature vector of the first image and calculate differences between the first feature vector and the feature vectors of the plurality of images stored in the database and stores the same in the database.

The processor may train a neural network on a plurality of different images, as input data, captured at different locations at different times to extract the sex of a person contained in the image and a feature vector and store the trained neural network in a memory.

The predetermined criterion may include the sex, time, and location information, wherein the processor restricts a search range of images containing the same person as the person contained in the probe image by performing first filtering of image data stored in the database based on the sex of the person contained in the probe image, performing second filtering based on the time when the image was captured, performing third filtering based on the location where the image was captured.

The processor may extract a candidate image group similar to the probe image by calculating Euclidean distances between feature vectors of images included in the restricted search range and the feature vector of the probe image.

An image search method according to an embodiment of the present specification includes: a database that stores a plurality of images captured from a plurality of cameras spaced apart from each other and differences in feature information between the plurality of images; a feature extraction unit that extracts the sex of a person contained in the image and a feature vector of the image; a processor that, when a probe image containing a person of interest is inputted, ranks the selected images based on similarity with the person of interest, and re-ranks the ranked images based on similarity, wherein the feature extraction unit includes a neural network that is trained on a plurality of different images, as input data, captured at different locations at different times to extract the sex of a person contained in the image and a feature vector, and the processor calculates differences between feature vectors of the plurality of images before the probe image is inputted.

Upon receiving a plurality of images captured from the plurality of cameras, the processor may store, in the database, the time when the image was captured, the location where the image was captured, and a sex and a feature vector of the image which are extracted through the feature extraction unit.

The database may pre-calculate and differences between feature vectors of the plurality of images, and upon receiving a first new image from one of the plurality of cameras, the processor may extract a first feature vector of the first image through the feature extraction unit and calculate differences between the first feature vector and the feature vectors of the plurality of images stored in the database and store the same in the database.

The processor may restrict the range of comparison targets to be compared with the probe, among the images included in the database, based on the sex of the person contained in the probe image, the time when the probe image was captured, and the location where the probe image was captured.

The processor may rank the selected images based on Euclidean distances between a feature vector of the probe image and feature vectors of the images selected as falling within the comparison target range.

The probe image may be inputted by the user through an input means of the image search device or selected from the database.

An image search method according to another embodiment of the present specification includes: storing images captured from a plurality of cameras spaced apart from each other and metadata of the images; and when a probe image containing a person of interest is inputted, selecting at least one image from the database, to search for an image containing the object of interest based on at least one predetermined criterion; ranking at least one candidate image similar to the probe image based on the distance between a feature vector of the probe image and a feature vector of the selected at least one image; and re-ranking the candidate image based on similarity between the probe image and the candidate image.

The metadata may include the sex of a person contained in the image, a feature vector, the time when the image was captured, and the location where the image was captured.

The storing in the database may include calculating differences between feature vectors of the plurality of images and storing the same in the database, before the probe image is inputted.

The image search method may further include: upon receiving a first new image from one of the plurality of cameras, extracting a first feature vector of the first image; and calculating differences between the first feature vector and the feature vectors of the plurality of images stored in the database and storing the same in the database.

The storing of metadata of the images may include: training a neural network on a plurality of different images, as input data, captured at different locations at different times to extract the sex of a person contained in the image and a feature vector; and obtaining the sex of a person in the image and a feature vector by using the trained neural network.

An image search method according to another embodiment of the present specification includes: storing, in a database, a plurality of images captured from a plurality of cameras spaced apart from each other and pre-calculated differences in feature information between the plurality of images; extracting the sex of a person contained in the image and a feature vector of the image by using a pre-trained artificial neural network; when a probe image containing a person of interest is inputted, selecting at least one image to be compared with the probe image from the database based on metadata of the probe image; ranking the selected images based on similarity with the person of interest; and re-ranking the ranked images based on similarity, wherein the artificial neural network is trained on a plurality of different images, as input data, captured at different locations at different times to extract and store the sex of a person contained in the image and a feature vector.

### Effect of Invention

According to an embodiment of the present specification, it is possible to search for the same object more efficiently in images captured from a plurality of cameras spaced apart from each other, by performing primary ranking based on similarity between the images and then performing re-ranking based on Jaccard distances between the images.

Furthermore, according to an embodiment of the present specification, it is possible to search for the same object more efficiently in images captured from a plurality of cameras spaced apart from each other, by limiting the size of a target being searched for in a database, in order to solve the problem of the rapid increase in the amount of computation needed to calculate the similarity between the images and calculate the Jaccard distances.

The effects of the present disclosure are not limited to the effects mentioned above, and other effects not mentioned will be clearly understood by those skilled in the art from the description of the claims.

### BRIEF DESCRIPTION OF THE DRAWING

The accompanying drawings, which are included as part of the detailed description to help the understanding of the present disclosure, provide embodiments of the present disclosure, and explain the technical features of the present disclosure together with the detailed description.

FIG. 1 is a diagram for explaining a surveillance camera system for implementing an image processing method for a surveillance camera according to an embodiment of the present specification.

FIG. 2 is a schematic block diagram of a surveillance camera according to an embodiment of the present specification.

FIG. 3 is a diagram for explaining an AI device (module) applied to training an object recognition model according to one embodiment of the present specification.

FIG. 4 is a flowchart of a method for image search in a surveillance camera system according to an embodiment of the present specification.

FIG. 5 is a diagram for explaining an example of constructing a database according to an embodiment of the present specification.

FIG. 6 is a diagram for explaining an example of filtering a search range in a database, in order to search for an image containing the same person as one being searched for.

FIG. 7A shows an example of performing primary ranking on images of people similar to a person being searched for, among images selected from a database, according to an embodiment of the present specification, and FIG. 7B shows an example of performing re-ranking after the primary ranking.

The accompanying drawings included as part of the detailed description to facilitate understanding of the present disclosure provide embodiments of the present disclosure and describe technical features of the present disclosure along with detailed descriptions.

### BEST MODE FOR CARRYING OUT THE INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

FIG. is a diagram for explaining a surveillance camera system for implementing an image processing method for a surveillance camera according to an embodiment of the present specification.

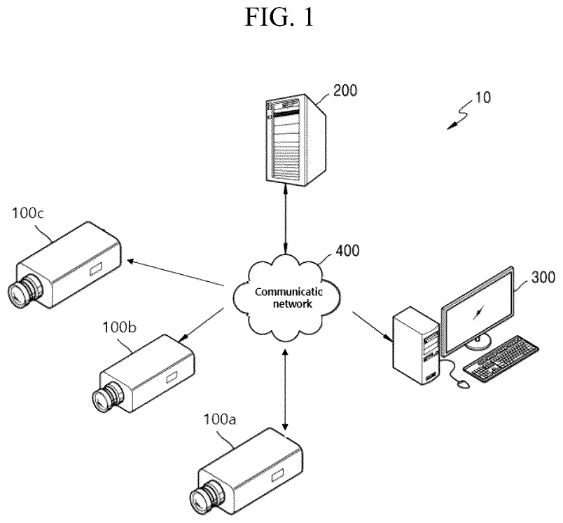

Referring to FIG. 1, an image management system 10 according to one embodiment of the present disclosure may include an image capture device (100a, 100b, 100c, hereinafter, for convenience of explanation, it is referred to as 100) and an image management server 200. The image capture device 100 may be an electronic imaging device disposed at a fixed location in a specific place, may be an electronic imaging device that can be moved automatically or manually along a predetermined path, or may be an electronic imaging device that can be moved by a person or a robot. The image capture device 100 may be an IP (Internet protocol) camera connected to the wired/wireless Internet and used. The image capture device 100 may be a PTZ (pan-tilt-zoom) camera having pan, tilt, and zoom functions. The image capture device 100 may have a function of recording a monitored area or taking a picture. The image capture device 100 may have a function of recording a sound generated in a monitored area. When a change such as movement or sound occurs in the monitored area, the image capture device 100 may have a function of generating a notification or recording or photographing. The image capture device 100 may receive and store the trained object recognition learning model from the image management server 200. Accordingly, the image capture device 100 may perform an object recognition operation using the object recognition learning model.

The image capture device 100 may include a plurality of image capture devices 100a, 100b, and 100c installed in different spaces. For example, the first image capture device 100a and the second image capture device 100b may be spaced apart by a first gap, and the second image capture device 100b and the third image capture device 100c may be spaced apart by a second gap. That is, the image capture devices 100a, 100b, and 100c may be systems that are implemented in the form of CCTVs that are disposed at locations where images of the same person can be captured at predetermined time intervals.

The image management server 200 may be a device that has a function of receiving, storing, and/or searching images captured through the image capture device 100 and/or images obtained by editing those captured images. The image management server 200 may perform analysis so as to meet the purpose of reception. For example, the image management server 200 may detect an object by using an object detection algorithm in order to detect an object from an image. The object detection algorithm may be an AI-based algorithm, and may detect an object by applying a pre-trained artificial neural network model.

According to an embodiment of the present specification, the image management server 200 may function as an image search device. The image search device allows for a quick and easy search of images obtained from a plurality of surveillance camera channels by entering a specific image, an object contained in the specific image, or a specific channel as a search condition. The image search device needs to build a database in advance in order for a user to easily search images, and an embodiment of the present specification proposes a method of limiting the amount of computation by limiting the size of a search target when performing an image search according to a specific search condition.

Meanwhile, the image management server 200 may be an NVR (Network Video Recorder) or DVR (Digital Video Recorder) which performs a function of storing images obtained through a network. Alternatively, it may be a CMS (Central Management System) capable of remotely monitoring images by managing and controlling the images in an integrated fashion. Meanwhile, the image management server 200 is not limited to them and may be a personal computer or a portable terminal. However, they are merely examples, and the technical idea of the present specification is not limited by these examples, and it is needless to say that any device can be used without any limitation as long as it is capable of displaying and/or storing a multimedia object it receives from one or more surveillance cameras through a network.

Meanwhile, the image management server 200 may store various learning models that suit the purpose of image analysis. Apart from the aforementioned learning models for object detection, a model capable of obtaining the moving speed of a detected object may be stored. Here, the above trained models may include a learning model that receives, as input data, images captured through the plurality of image capture devices 100a, 100b, and 100c, that is, images that are captured at different times at different locations, and outputs the sex of a person contained in the captured images and feature vectors of the images.

Moreover, the image management server 200 may analyze a received image and generate metadata and index information for the metadata. The image management server 200 may analyze image information and/or audio information included in the received image together or separately and generate metadata and index information for the metadata. The metadata may further include information on the time and location where the image was captured.

The image management system 10 may further include an external device 300 capable of performing wired/wireless communication with the image capture device 100 and/or the image management server 200.

The external device 300 may send an information provision request signal to the image management server 200 requesting to provide an entire image or part of it. The external device 300 may send an information provision request signal to the image management server 200 requesting information about the presence of an object as a result of image analysis, the moving speed of the object, a shutter speed adjusted to the moving speed of the object, the amount of noise removal according to the moving speed of the object, a sensor gain value, etc. In addition, the external device 300 may send an information provision request signal to the image management server 200 requesting metadata obtained by image analysis and/or index information for the metadata.

The image management system 10 may further include a communication network 400 that is a wired/wireless communication path between the image capture device 100, the image management server 200, and/or the external device 300. The communication network 400 may include, for example, a wired network such as LANs (Local Area Networks), WANs (Wide Area Networks), MANs (Metropolitan Area Networks), ISDNs (Integrated Service Digital Networks), and a wireless network such as wireless LANs, CDMA, Bluetooth, and satellite communication, but the scope of the present disclosure is not limited thereto.

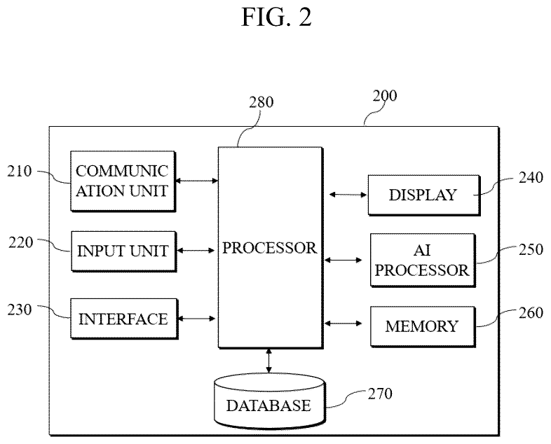

FIG. 2 is a schematic block diagram of a surveillance camera according to an embodiment of the present specification.

Referring to FIG. 2, the image search device 200 may include a communication unit 210, an input unit 220, an interface 230, a display 240, an AI processor 250, a memory 260, and a database 270.

The image search device 200 may extract feature information of an object contained in an image by analyzing metadata transmitted from a camera 100. Also, it builds a database the user can search by comparing with feature information of a stored object. To this end, the image search device 200 includes a processor 280, a memory 260, an input unit 220, and a display 240. Also, these components may be interconnected via a bus and communicate with one another.

The communication unit 210 may receive video data, audio data, still images, and/or metadata from the camera device 100. The communication unit 210 according to an embodiment may receive video data, audio data, still images, and/or metadata in real time from the camera 100. The communication interface may perform a communication function of at least one of wired/wireless LAN (Local Area Network), Wi-Fi, ZigBee, Bluetooth, and Near Field Communication.

All components included in the processor 280 may be connected to a bus via at least one interface or adapter or directly connected to the bus. In addition, the bus may be connected to other sub systems apart from the above-described components. The bus may include a memory bus, a memory controller, a peripheral bus, and a local bus.

The processor 280 controls overall operation of the image search device 200. For example, upon receiving metadata from the camera 100 or a separate VA engine, it may extract feature information of an object contained in an image from the metadata and store it in the database 270. Examples of the metadata, in the present specification, may include the sex of an object (person) contained in the image, feature information of the image, information on the location of the image capture device, information on the time when the image was captured, etc.

According to an embodiment of the present specification, the processor 280 and/or AI processor 250 may implement a function of a feature extraction unit (not shown) for extracting feature information from an image, and the feature extraction unit may be configured as a module independent from the processor 280 and the AI processor 250.

According to an embodiment of the present specification, differences between feature vectors of images may be additionally stored based on feature vector information of all images stored in the database 270. The differences between the feature vectors may be used as a first basis for determining the similarity between the images. Accordingly, if the database 270 has N images stored therein, a total of N(N−1) feature vector differences may be configured and stored. Here, upon receiving an (N+1)th image through a surveillance camera, the processor 280 may calculate feature vector differences between ImageN+1 and I1, I2, I3, . . . IN, respectively, and configure a total of N(N+1) feature vector differences to configure a database.

Consequently, according to an embodiment of the present specification, since all feature vector differences between images are calculated and stored before a specific search condition is inputted, as described above, the resources required to calculate the feature vector differences can be minimized in an actual process of performing an image search.

The processor 280 may be preferably a CPU (Central Processing Unit), an MCU (Micron Controller Unit), or a DSP (Digital Signal Processor), but is not limited to them and a variety of logical operation processors.

The memory 260 stores various kinds of object information, and the database 270 is built by the processor 280. The memory 260 includes a non-volatile memory device and a volatile memory device. Preferably, the non-volatile memory device may be low in volume, lightweight, and resistant to external shocks, and the volatile memory may be a DDR SDRAM.

The image search device 200 may be connected to a network. Accordingly, the image search device 200 may be connected to other devices over a network and send and receive various data and signals, including metadata.

The display 240 may show results of a search performed according to a search condition entered by the user in order for the user to see.

The input unit 220 may include a mouse, a keyboard, a joystick, a remote control, etc. Such an input unit may be connected to a bus via an input interface 141 including a serial port, a parallel port, a game port, a USB, etc. However, if the image search device 200 provides a touch function, the display 240 may include a touch sensor. In this case, the input unit 220 may not be required, and the user may enter a touch signal directly through the display 240.

Even if the image search device 200 provides a touch function, a touch pad may be provided as the input unit 220 unless the display 240 includes a touch sensor. Various types of display may be used as the display 240, including an LCD (Liquid Crystal Display), an OLED (Organic Liquid Crystal Display), a CRT (Cathode Ray Tube), and a PDP (Plasma Display Panel). The display 240 may be connected to a buys via a video interface (not shown), and data transfer between the display 240 and the bus may be controlled by a graphics controller 132.

The interface 230 may include a network interface, a video interface, an input interface, etc. The network interface may include a network interface card, a modem, etc.

The AI processor 250 is for artificial intelligence image processing, and according to an embodiment of the present specification, applies a deep learning-based, object detection algorithm that is trained on an object of interest in images obtained through a surveillance camera system. In embodiments of the present specification, YOLO (You Only Look Once) algorithm may be applied in object detection. YOLO is an AI algorithm that is suitable for a surveillance camera that processes real-time video since it detects an object at a fast speed. As opposed to other object-based algorithms (Faster R-CNN, R_FCN, FPN-FRCN, etc.), the YOLO algorithm outputs a bounding box indicating the location of each object that has passed through a single neural network only once, after resizing a single input image, and the classification probability of what the object is. Lastly, a single object is detected once through Non-max suppression.

Meanwhile, it should be noted that an object detection algorithm disclosed in the present specification is not limited to the above YOLO and may be implemented as various deep learning algorithms.

Meanwhile, a learning model for object detection applied in the present specification may include a neural network model that, if the above-mentioned object contained in an image is a person, is trained to extract the sex of the person. As training data for training the neural network model, a plurality of different images obtained from a plurality of surveillance cameras spaced apart by a certain distance or longer, that are captured at different times at different locations, are defined as input data, and the neural network model may be trained to design a network that allows for extracting sex information and feature information of the images from the plurality of images.

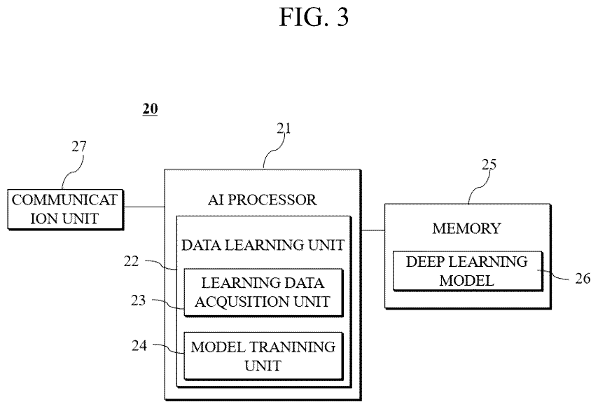

FIG. 3 is a diagram for explaining an AI device (module) applied to training an object recognition model according to one embodiment of the present specification.

Referring to FIG. 3, the AI device 20 may include an electronic device including an AI module capable of performing AI processing, or a server including an AI module. In addition, the AI device 20 may be included the image capture device 100 or the image management server 200 as at least a part thereof to perform at least a part of AI processing together.

The AI processing may include all operations related to a control unit of the image capture device 100 or the image management server 200. For example, the image capture device 100 or the image management server 200 may AI-process the obtained image signal to perform processing/determination and control signal generation operations.

The AI device 20 may be a client device that directly uses the AI processing result or a device in a cloud environment that provides the AI processing result to other devices. The AI device 20 is a computing device capable of learning a neural network, and may be implemented in various electronic devices such as a server, a desktop PC, a notebook PC, and a tablet PC.

The AI device 20 may include an AI processor 21, a memory 25, and/or a communication unit 27.

Here, the neural network for recognizing data related to image capture device (100) may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present disclosure.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and by applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquisition unit 23 may acquire learning data required for a neural network model for classifying and recognizing data. According to one embodiment of the present disclosure, the learning data may include information on object of interest designated by a user in an image captured by the image capture device, and information on object of non-interest selected from a region excluding the object of interest in the image. The information on object of interest may include location information of the object of interest in the image. The location information may include coordinate information of a bounding box of the object of interest. The coordinate information may include vertex coordinates and center coordinates of the bounding box. Meanwhile, the object of non-interest in the learning data may be randomly designated by the processor or selected based on a predetermined criterion.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When the neural network model is trained, the model training unit 24 may store the trained neural network model in a memory. The model training unit 24 may store the trained neural network model in the memory of the server connected to the AI device 20 through a wired or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

Further, the learning data selector can select data for learning from the learning data acquired by the learning data acquiring unit 23 or the learning data preprocessed by the preprocessor. The selected learning data can be provided to the model learning unit 24. For example, the learning data selector can select only data for objects included in a specific area as learning data by detecting the specific area in an image acquired through a camera of a vehicle.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 may transmit the AI processing result of the AI processor 21 to an external electronic device. For example, the external electronic device may include a surveillance camera, a Bluetooth device, an autonomous vehicle, a robot, a drone, an AR (augmented reality) device, a mobile device, a home appliance, and the like.

Meanwhile, the AI device 20 shown in FIG. 3 has been functionally divided into the AI processor 21, the memory 25, the communication unit 27, and the like, but the above-described components are integrated as one module and it may also be called an AI module.

In the present disclosure, at least one of a surveillance camera, an autonomous vehicle, a user terminal, and a server may be linked to an AI module, a robot, an augmented reality (AR) device, a virtual reality (VR) device, a device related to a 5G service, and the like.

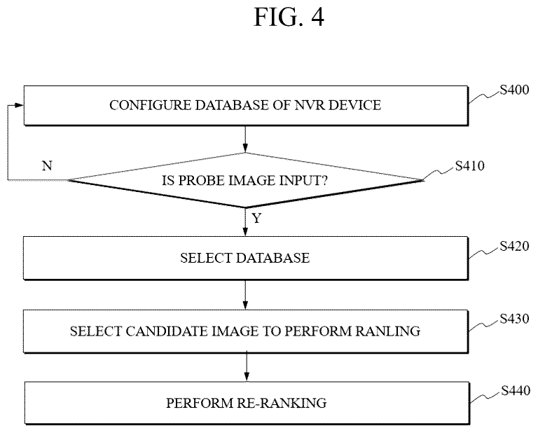

FIG. 4 is a flowchart of a method for image search in a surveillance camera system according to an embodiment of the present specification. The image search method disclosed in FIG. 4 may be implemented through the processor 280 of the image search device 200 explained with reference to FIG. 2.

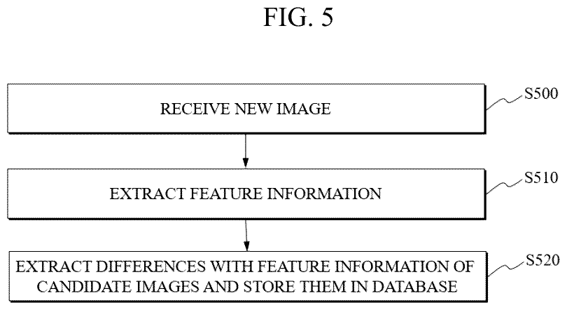

Referring to FIG. 4, the processor 280 may configure a database for the image search device NVR (S400). The database may be updated by extracting an image distance between existing image data and new image data. Here, the image distance may refer to feature information of an image obtained through an artificial intelligence learning model. The feature information of an image may refer to a feature vector of the image, and also may refer to a difference between feature vectors of two images. A process of configuring and updating a database will be concretely described later with reference to FIG. 5.

The database may store pre-calculated differences between feature vectors of images, whereby, upon receiving a request later from the user of the image search device to search for a specific object, image distance information stored in the database may be utilized, thereby eliminating the need to additionally calculate feature vector differences.

The processor 280 may check for an input of a probe image (S410). Here, the probe image may refer to an image containing an object that is desired to be searched for through the image search device 200. The probe image may be inputted by the user through an input unit of the image search device 200. The probe image also may be inputted as an image that is desired to be searched for through the image search device through a method in which one of images captured from a plurality of surveillance cameras spaced apart from each other and stored in a memory of the image search device 200.

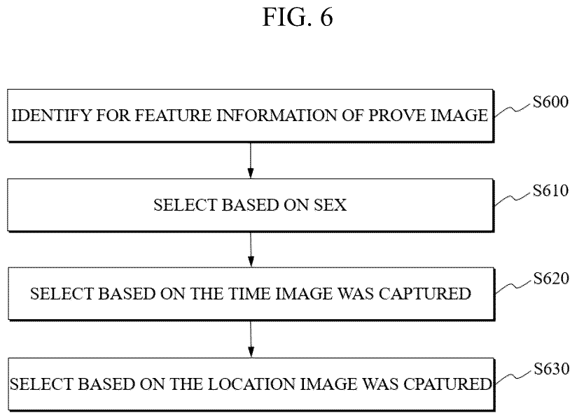

Upon determining that it has received a request from the user to search for a specific image (or object) (S410:Y), the processor 280 may select an image to be included in a comparison group with the probe image according to a predetermined criterion (S420). A feature of the probe image, the place of installation of the camera that captured the image, the time when the image was captured, etc. may be considered as the predetermined criterion, which will be described more specifically with reference to FIG. 6.

Once images to be compared with the probe image are selected from the database in S420, the processor 280 may retrieve at least one image as a candidate image by comparing the degrees of similarity between the selected images and the probe image, and rank (arrange) the retrieved candidate images based on the degrees of similarity (S430).

Here, the degrees of similarity between the images may refer to the Euclidean distances between a feature vector of probe image data and feature vectors of images selected from the database. In a case where a k-nearest neighbor search algorithm, for example, is used as a way of determining similarity between a target image and a comparison image, if feature information of a person contained in the probe image and feature information of a person contained in the comparison image are clearly distinguishable, the processor 280 may effectively determine whether they are the same person. However, if there are a number of people in the database who are similar in body shape or clothing to the person being searched for, they may be assessed as having high similarity, and there may be an instance where some images that are retrieved as high-priority images are not images of the same person.

According to an embodiment of the present specification, an image group on which primary ranking has been performed in S430 may be re-ranked in order to solve the aforementioned problem (S440).

The processor 280 may calculate the Euclidean distances and perform primary ranking in the order of similarity between feature vectors, and then calculate the Jaccard distances by the following Mathematical Formula 1:

$$\text{?}$$

$$\text{?} \text{indicates text missing or illegible when filed}$$

where dⱼ(p, gᵢ) is the Jaccard distance between the probe image and an i-th candidate image, among the candidate images (ranked images) stored in the database,
d_{p,gi} is the Euclidean distance between the probe image and the i-th candidate image, among the candidate images (ranked images) stored in the database, and
N is the number of candidate images stored in the database.

The more similar the probe mage and the i-th image, among the candidate images in the database, the higher the value of the Jaccard distance. This gives more higher reliability to similarity between sets of retrieved candidate images and therefore can be used as a basis for determining they are images of the same person.

According to an embodiment, the processor 280 may readjust the order of priority by obtaining the final distance through a weighted sum of the calculated Jaccard distance and the Euclidean distance.

FIG. 5 is a diagram for explaining an example of configuring a database according to an embodiment of the present specification.

Referring to F IG. 5, the processor 280 may receive a new image (hereinafter, first image) (S500). The new image is an image that has not been stored before in the database, that is received from a plurality of cameras spaced apart from each other.

In an embodiment of the present specification, in order to utilize the first image later in an image search process, information related to the first image may be processed and additionally stored in the database.

Here, the information related to the first image may include metadata of the first image. The metadata of the first image may include information on the location and time the first image was captured.

Moreover, the information related to the first image may include feature information of the first image. The feature information of the first image may include a feature vector extracted through an AI feature information extraction process (S510).

The processor 280 may extract differences between a feature vector of the first image and feature vectors of images stored in the database and store them in the database (S520). That is, feature vector differences among all images stored in the database are calculated and stored. Thus, if a specific image among the images stored in the database is selected as a probe image, the processor 280 may rank similar images based on the feature vector differences stored in the database, without having to additionally calculate the similarity between the images, in order to search for an image containing the same person as the person contained in the probe image.

Meanwhile, as illustrated in FIG. 5, upon receiving a new image whose feature information or the like is not stored in the database, the processor may perform an operation of extracting feature information (including a feature vector) of the new image and extracting differences with feature vectors of the images stored in the database, and reconfigure the database so as to determine the similarity between the new image and the stored images.

FIG. 6 is a diagram for explaining an example of filtering a search range in a database, in order to search for an image containing the same person as one being searched for.

According to an embodiment of the present specification, when the user of the image search device selects an object they want to search for, a database selection unit sorts candidates for the same person as the object of interest based on a feature vector of the selected object, the sex of the person, and temporal and spatial information.

Referring to FIG. 6, the processor 280 may check for feature information of a probe image (S600). As described above, the feature information of the probe image may include a feature vector of the image, the location where the image was captured, the time when the image was captured, the sex of a person contained in the image, and so on. As described previously, information such as the location where the image was captured and the time when the image was captured may be received together in the form of metadata, and the feature vector information, the sex information, etc. may be extracted through an AI image analysis process by the image search device 200.

First, the processor 280 may select only data involving the same sex within the database based on the sex of the object of interest contained in the probe image (S610). In this case, if there is an image in the database in which both a male and a female are present, it may be selected as a comparison image.

Also, the processor 280 may additionally select from the database only data involving times similar to the time when the probe image was captured (S620). This is to restrict a search range to similar times on the same date.

Lastly, the processor 280 may select data based on the location where the probe image was captured (S630). Meanwhile, since the image search device has obtained information on a plurality of cameras installed at spatially separate locations, a search range for the same person may be restricted largely to information on cameras installed at adjacent locations.

In this way, according to an embodiment of the present specification, in order to reduce the amount of computation required in a re-ranking process, a target range for determining the similarity with the probe image may be narrowed based on sex, the time when the image was captured, and the location where the image was captured.

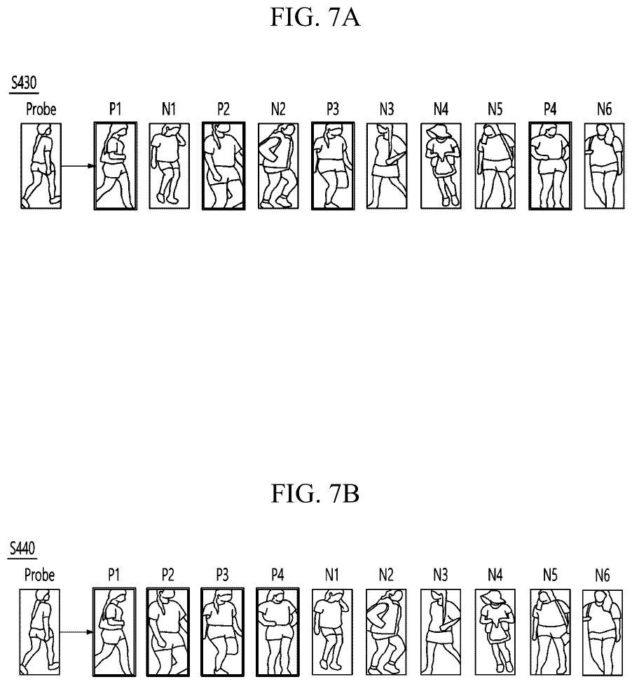

FIG. 7A shows an example of performing primary ranking images of people similar to a person being searched for, among images selected from a database, according to an embodiment of the present specification, and FIG. 7B shows an example of performing re-ranking after the primary ranking.

FIG. 7A illustrates results of S430 (the selection and ranking of candidate images) in FIG. 4. For example, similarity may be determined by comparing the Euclidean distances between the probe image and the images selected from the database, and as a result, the degrees of similarity may be determined in the order: P1, N1, P2, N2, P3, N3, N4, N5, P4, and N6. However, N1 is actually not an image of the same person as the person of interest in the probe image, but has higher priority than P2 which is an image of the same person. Likewise, N2 has higher priority than P3, and N3, N4, and N5 has higher priority than P4 (it is assumed that images containing the same person as the person of interest in the probe image are P1, P2, P3, and P4).

That is, in FIG. 7A, the comparison is made merely based on feature vector differences between images, and therefore non-identical people may have a higher degree of similarity than the same person since the clothing, outer appearance, etc. of the person of interest are taken into consideration when setting the feature vectors.

In the present specification, the degrees of priority may be re-ranked by additionally calculating the Jaccard distances from the results in FIG. 7A, and as a result, P1, P2, P3, and P4 may be sorted as having higher priority than N1, N2, N3, N4, N5, and N6, thereby increasing the accuracy of image search.

The present specification described above can be implemented as computer-readable code on a medium in which a program is recorded. Computer-readable media include all types of recording devices in which data readable by a computer system is stored. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc., and also include those implemented in the form of a carrier wave (e.g., transmission over the Internet). Accordingly, the above detailed description should not be construed as limiting in all respects and should be considered illustrative. The scope of the present specification should be determined by reasonable interpretation of the appended claims, and all changes within the equivalent scope of this disclosure are included in the scope of this disclosure.

What is claimed is:

1. An image search device comprising:
a database configured to store images captured from a plurality of cameras spaced apart from each other and metadata of the images; and
a processor configured to, when a probe image containing a person of interest is inputted, select at least one image from the database,
search for an image containing the object of interest based on at least one predetermined criterion,
extract at least one candidate image similar to the probe image based on the distance between a feature vector of the probe image and a feature vector of the selected at least one image, and
re-ranks the candidate image based on similarity between the probe image and the candidate image.

2. The image search device of claim 1, wherein the metadata comprises the sex of a person contained in the image, a feature vector, the time when the image was captured, and the location where the image was captured.

3. The image search device of claim 2, wherein the processor pre-calculates differences between feature vectors of the plurality of images and stores the same in the database, before the probe image is inputted.

4. The image search device of claim 3, wherein, upon receiving a first new image from one of the plurality of cameras, the processor extracts a first feature vector of the first image and calculates differences between the first feature vector and the feature vectors of the plurality of images stored in the database and stores the same in the database.

5. The image search device of claim 2, wherein the processor trains a neural network on a plurality of different images, as input data, captured at different locations at different times to extract the sex of a person contained in the image and a feature vector and stores the trained neural network in a memory.

6. The image search device of claim 2, wherein the predetermined criterion comprises the sex, time, and location information,
wherein the processor restricts a search range of images containing the same person as the person contained in the probe image by performing first filtering of image data stored in the database based on the sex of the person contained in the probe image, performing second filtering based on the time when the image was captured, performing third filtering based on the location where the image was captured.

7. The image search device of claim 6, wherein the processor extracts a candidate image group similar to the probe image by calculating Euclidean distances between feature vectors of images included in the restricted search range and the feature vector of the probe image.

8. The image search device of claim 1, wherein the similarity comprises similarity between images based on Jaccard distance.

9. An image search device comprising:
a database that stores a plurality of images captured from a plurality of cameras spaced apart from each other and differences in feature information between the plurality of images;
a feature extraction unit that extracts the sex of a person contained in the image and a feature vector of the image;
a processor that, when a probe image containing a person of interest is inputted, ranks selected images based on similarity with the person of interest, and re-ranks the ranked images based on similarity,
wherein the feature extraction unit includes a neural network that is trained on a plurality of different images, as input data, captured at different locations at different times to extract the sex of a person contained in the image and a feature vector, and
wherein the processor calculates differences between feature vectors of the plurality of images before the probe image is inputted.

10. The image search device of claim 9, wherein, upon receiving a plurality of images captured from the plurality of cameras, the processor stores, in the database, the time when the image was captured, the location where the image was captured, and a sex and a feature vector of the image which are extracted through the feature extraction unit.

11. The image search device of claim 10, wherein, upon receiving a first new image from one of the plurality of cameras, the processor extracts a first feature vector of the first image through the feature extraction unit and calculates differences between the first feature vector and the feature vectors of the plurality of images stored in the database and stores the same in the database.

12. The image search device of claim 9, wherein the processor restricts the range of comparison targets to be compared with the probe, among the images included in the database, based on the sex of the person contained in the probe image, the time when the probe image was captured, and the location where the probe image was captured.

13. The image search device of claim 11, wherein the processor ranks the selected images based on Euclidean distances between a feature vector of the probe image and feature vectors of the images selected as falling within the comparison target range.

14. The image search device of claim 9, wherein the probe image is inputted by the user through an input means of the image search device or selected from the database.

15. An image search method comprising:
storing images captured from a plurality of cameras spaced apart from each other and metadata of the images; and
when a probe image containing a person of interest is inputted, selecting at least one image from the database, to search for an image containing the object of interest based on at least one predetermined criterion;
ranking at least one candidate image similar to the probe image based on the distance between a feature vector of the probe image and a feature vector of the selected at least one image; and
re-ranking the candidate image based on similarity between the probe image and the candidate image.

16. The image search method of claim 15, wherein the metadata includes the sex of a person contained in the image, a feature vector, the time when the image was captured, and the location where the image was captured.

17. The image search method of claim 16, wherein the storing in the database includes calculating differences between feature vectors of the plurality of images and storing the same in the database, before the probe image is inputted.

18. The image search method of claim 17, further comprising:
upon receiving a first new image from one of the plurality of cameras, extracting a first feature vector of the first image; and
calculating differences between the first feature vector and the feature vectors of the plurality of images stored in the database and storing the same in the database.

19. The image search method of claim 16, wherein the storing of metadata of the images includes:
training a neural network on a plurality of different images, as input data, captured at different locations at different times to extract the sex of a person contained in the image and a feature vector; and
obtaining the sex of a person in the image and a feature vector by using the trained neural network.

20. An image search method comprising:
storing, in a database, a plurality of images captured from a plurality of cameras spaced apart from each other and pre-calculated differences in feature information between the plurality of images;
extracting the sex of a person contained in the image and a feature vector of the image by using a pre-trained artificial neural network;
when a probe image containing a person of interest is inputted, selecting at least one image to be compared with the probe image from the database based on metadata of the probe image;
ranking the selected images based on similarity with the person of interest; and
re-ranking the ranked images based on Jaccard distance,
wherein the artificial neural network is trained on a plurality of different images, as input data, captured at different locations at different times to extract and store the sex of a person contained in the image and a feature vector, and
wherein differences between feature vectors of the plurality of images are calculated and stored in the database, before the probe image is inputted.
